(19) United States
(12) Patent Application Publication
(10) Pub. No.: US 2021/0001476 A1
(43) Pub. Date: Jan. 7, 2021

(54) ROBOT

(71) Applicant: LG ELECTRONICS INC., Seoul (KR)

(72) Inventors: Seyoung WOO, Seoul (KR); Hyunkyoo PARK, Seoul (KR)

(73) Assignee: LG ELECTRONICS INC., Seoul (KR)

(21) Appl. No.: 16/839,557

(22) Filed: Apr. 3, 2020

(30) Foreign Application Priority Data
Jul. 1, 2019 (KR) PCT/KR2019/007971

(51) Int. Cl. B25J 9/00; G06N 3/00

(52) U.S. Cl. CPC B25J 9/0003; G06N 3/008

(57) ABSTRACT

A pet robot in a shape of an animal is provided. The pet robot may include a body, a first actuator provided in the body, a rotating body provided in the body and connected to the first actuator to rotate, a second actuator fastened to the rotating body, a thigh portion connected to the second actuator at an upper portion thereof to rotate, a third actuator fastened to a lower portion of the thigh portion, and a calf portion positioned at a lower side of the thigh portion and connected to the third actuator at an upper portion thereof to rotate.

### CROSS-REFERENCE TO RELATED APPLICATION

The present application claims priority under 35 U.S.C. 119 to Patent Application No. PCT/KR2019/007971, filed on Jul. 1, 2019, which is hereby incorporated by reference in its entirety.

### BACKGROUND

The present disclosure relates to a robot, and more particularly, to a robot including a leg movable relative to a body.

For factory automation, robots have been developed for industrial use.

Recently, medical robots and aerospace robots, as well as robots that can be used in daily life, have been developed as the applications of robots have been further expanded.

In particular, a pet robot modeled after the shape of a pet animal such as a dog may provide emotional satisfaction to users. Such a pet robot may operate similar to a real pet and output a sound. The users do not need to feed the pet robot or clean up its waste, thereby reducing the hassle and burden of busy modern people while providing emotional satisfaction just like a real pet.

### SUMMARY

An object of the present disclosure is to provide a robot having a leg with a minimum moving load.

According to an embodiment, a robot may include a body (torso member), a first actuator embedded in the body, a rotating body provided in the body and connected to the first actuator to rotate, a second actuator fastened to the rotating body, a thigh portion connected to the second actuator at an upper portion thereof to rotate, a third actuator fastened to a lower portion of the thigh portion, a calf portion positioned at a lower side of the thigh portion and connected to the third actuator at an upper portion thereof to rotate.

The calf portion may be formed with an upper receiving portion open toward the rotating body to receive at least a part of the second actuator.

The calf portion may be provided with a lower receiving portion positioned at a lower side of the upper receiving portion and open toward the body or a lower side of the body to receive a part of an upper portion of the third actuator.

A rotation axis of the rotating body may be perpendicular to a rotation axis of the thigh portion and parallel to a rotation axis of the calf portion.

The rotation axis of the rotating body may be positioned on a same horizontal plane as the rotation axis of the thigh portion.

The calf portion may include a body, and a connection portion formed at one side of the body and connected to the third actuator.

The body may be provided with an opening portion open toward a lower side of the body.

The robot may further include a guide body fixed to the body and positioned between the first actuator and the rotating body to guide rotation of the rotating body.

The guide body may be provided with a through hole and the first actuator may be connected to the rotating body via the through hole.

According to another embodiment, a robot may include a body, a first actuator provided in the body, a rotating body provided in the body and connected to the first actuator to rotate, a second actuator fastened to the rotating body, a thigh portion connected to the second actuator at an upper portion thereof to rotate, a third actuator fastened to a lower portion of the thigh portion, a calf portion spaced apart from a lower side of the third actuator, and a link assembly configured to rotate the calf portion while maintaining a predetermined angle with respect to the thigh portion.

The link assembly may include a first link configured to connect the third actuator and the calf portion, and a second link positioned behind the first link to connect the thigh portion and the calf portion.

The calf portion may include a body, a link connection formed in one side of the body and connected to the first link, a hook portion formed at an upper end of the body and connected to the second link.

The body may be formed with an opening portion configured to be open to a lower side of the body.

The calf portion may further include a cover configured to cover the opening portion and rotatably connected to the first link.

The cover may be formed with a dislodgement preventing portion configured to prevent the second link from being dislodged from the hook portion.

The robot may further include a foot body rotatably connected to a lower end of the calf portion.

The first link may include a body, a lower connection portion positioned at a lower side of the body and rotatably connected to the calf portion, an extension portion extending upward from a front surface of the body, and an upper connection portion provided at one side of the extension portion and connected to the third actuator.

The body may be formed with an opening portion configured to be open to a lower side of the body.

According to still another embodiment, a robot may include a body, a first front actuator provided in a front portion of the body, a front rotating body provided in the front portion of the body and connected to the first front actuator to rotate, a second front actuator fastened to the front rotating body, a front thigh portion connected to the second front actuator at an upper portion thereof to rotate, a third front actuator fastened to a lower portion of the front thigh portion, a front calf portion positioned at a lower side of the front thigh portion and connected to the third front actuator at an upper portion thereof to rotate, a rear actuator provided in a rear portion of the body, a rear rotating body provided in the rear portion of the body and connected to the first rear actuator to rotate, a second rear actuator fastened to the rear rotating body, a rear thigh portion connected to the second rear actuator at an upper portion thereof to rotate, a third rear actuator fastened to a lower portion of the rear thigh portion, a rear calf portion spaced apart from a lower side of the third rear actuator, and a link assembly configured to rotate the rear calf portion while maintaining the rear calf portion at a predetermined angle with respect to the rear thigh portion.

A front to rear distance between the third front actuator and the third rear actuator may increase as it goes downward.

### BRIEF DESCRIPTION OF THE DRAWINGS

FIG. 1 is a side view of a robot according to an embodiment of the present disclosure.

FIG. 2 is a side view of a robot according to an embodiment of the present disclosure, which is sitting on the floor.

FIG. 3 is a cross-sectional view of each leg according to an embodiment of the present disclosure, which is taken in a front to back direction.

FIG. 4 is a perspective view of a front leg according to an embodiment of the present disclosure.

FIG. 5 is an exploded perspective view of the front leg shown in FIG. 4.

FIG. 6 is a cross-sectional view of the front leg which is taken in a left-right direction according to an embodiment of the present disclosure.

FIG. 7 is a perspective view of a rear leg according to an embodiment of the present disclosure.

FIG. 8 is a perspective view of the rear leg shown in FIG. 7 viewed in another direction.

FIG. 9 is an exploded perspective view of the rear leg shown in FIG. 7.

FIG. 10 is a cross-sectional view of the rear leg according to the embodiment of the present disclosure, which taken in a left-right direction.

FIGS. 11A, 11B and 11C are views for describing operation of a link assembly of the present disclosure.

### DETAILED DESCRIPTION OF THE EMBODIMENTS

Hereinafter, specific embodiments of the present disclosure will be described in detail with reference to the drawings.

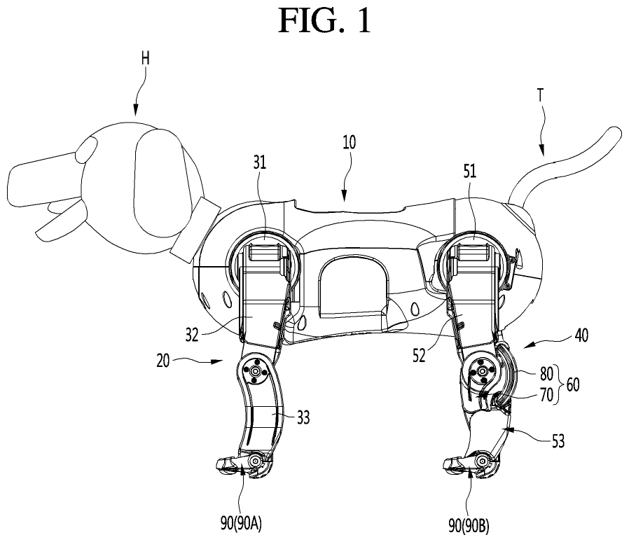

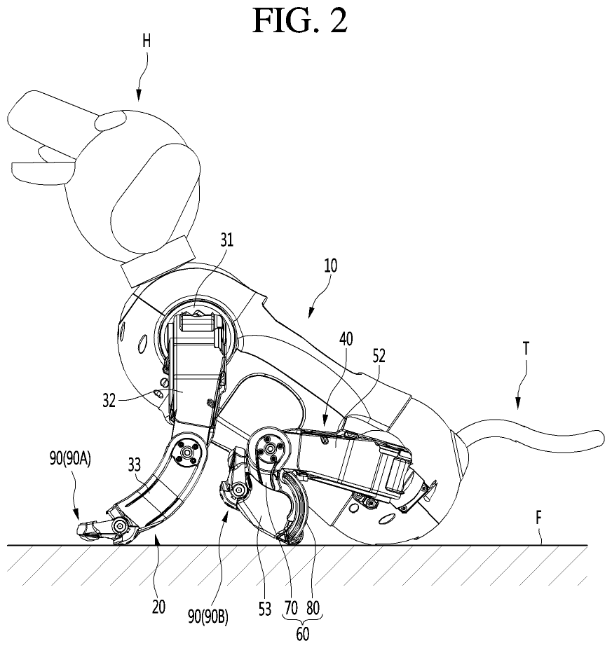

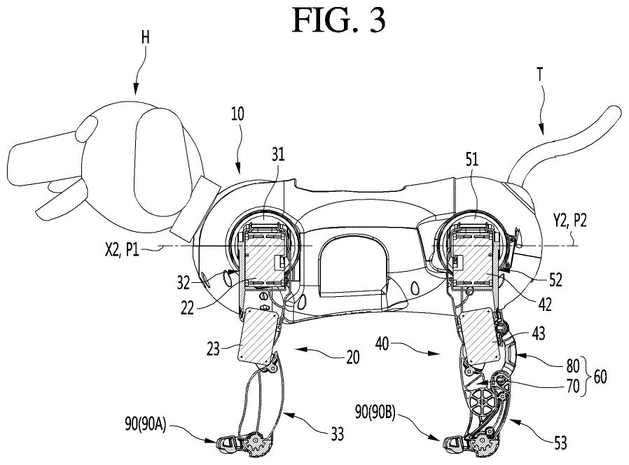

FIG. 1 is a side view of a robot according to an embodiment of the present disclosure, FIG. 2 is a side view of a robot according to an embodiment of the present disclosure, which is sitting on the floor, and FIG. 3 is a cross-sectional view of each leg according to an embodiment of the present disclosure, which is taken in a front to back direction.

A robot according to the embodiment of the present disclosure may be a pet robot. As an example, the robot may have a shape substantially similar to a dog, but is not limited thereto.

The robot may include a body 10, a head H, a tail T, and legs 20 and 40.

The body 10 may be elongated in a front-rear direction, and an internal space in which various components are embedded may be formed therein. The body 10 is preferably a streamlined body to resemble the body of an actual pet.

The head H may correspond to the head of the pet and may be provided at the front of the body 10. The tail T may correspond to the tail of the pet and may be provided at the rear of the body 10.

The legs 20 and 40 may be movably connected to body 10. Each of the legs 20 and 40 may include at least one joint structure to be folded or unfolded, thereby enabling the robot to implement a motion similar to the real pet.

In more detail, a plurality of legs 20 and 40 may include a front leg 20 and a rear leg 40.

The front leg 20 may correspond to the front leg of the pet and may be provided with a pair of left and right legs. The pair of front legs 20 may be provided at both sides of the front portion of the body 10, respectively.

The rear leg 40 may correspond to the rear leg of the pet and may be provided with a pair of left and right legs. The pair of rear legs 40 may be provided at both sides of the rear portion of the body 10, respectively.

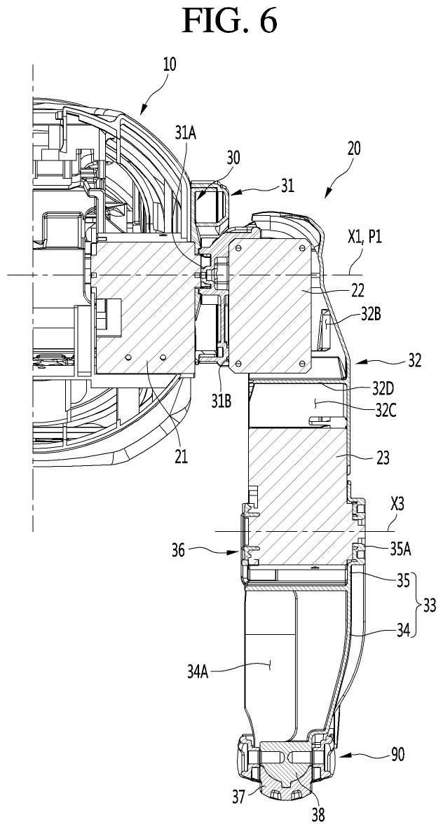

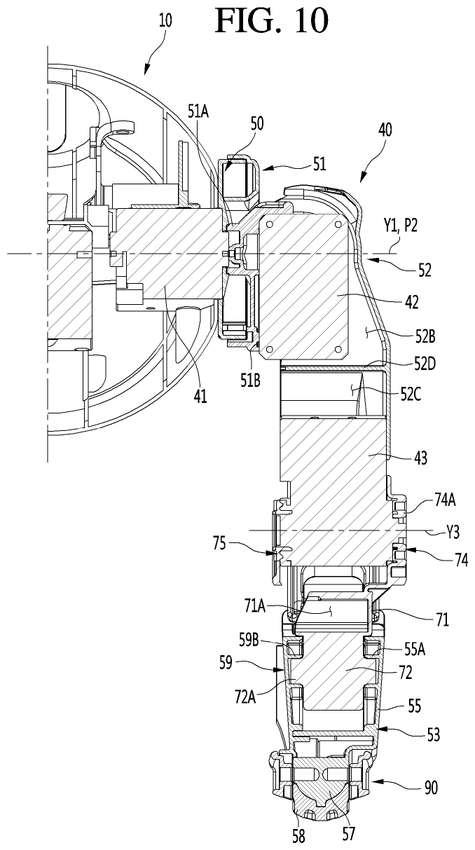

The leg 20 or 40 is provided with a first actuator 21 or 41 (see FIGS. 6 and 10) embedded in the body 10, and a first actuator 21 (built in the body 10), a rotating body 31 or 51 provided in the body 10 and connected to the first actuator 21 or 41 to rotate, a second actuator 22 or 42 fastened to the rotating body 31 or 51, a thigh portion 32 or 52 connected to the second actuator 22 or 42 at an upper portion thereof, a third actuator 23 or 43 fastened to the thigh portion 32 or 52 at a lower portion thereof, and a calf portion 33 or 53 disposed at a lower side of the thigh portion 32 or 52 and connected to the third actuator 23 or 43 at an upper portion to rotate.

In more detail, the front leg 20 may include a front rotating body 31, a front thigh portion 32, a front calf portion 33, a first front actuator 21 (see FIG. 6), a second front actuator 22 and a third front actuator 23.

The front rotating body 31 may be provided at the front portion of the body 10. The front rotating body 31 may have a disc shape. The front rotating body 31 may be connected to the first front actuator 21 (see FIG. 6) embedded in the front portion of the body 10.

The first front actuator 21 may rotate the front rotating body 31 about a rotation axis X1 (see FIG. 6) elongated in a left-right direction.

The front thigh portion 32 may be elongated in a vertical direction. The front thigh portion 32, more specifically, the upper portion of the front thigh portion 32 may be located outer than the front rotating body 31. The upper portion of the front thigh portion 32 may be connected to the front rotating body 31, and the front thigh portion 32 may be rotated in a front to back direction by a rotation of the front rotating body 31.

In addition, the front thigh portion 32 may be connected to the second front actuator 22 fastened to the front rotating body 31. The second front actuator 22 may connect the upper portion of the front thigh portion 32 to the front rotating body 31.

The second front actuator 22 may rotate the front thigh portion 32 about the rotation axis X2 which is elongated in a front-rear direction. Therefore, the front thigh portion 32 may rotate in a left-right direction with respect to the front rotating body 31.

The front calf portion 33 may be elongated in a vertical direction. The front calf portion 33 may be located at the lower side of the front thigh portion 32. An upper end of the front calf portion 33 may be connected to a lower end of the front thigh portion 32. The front calf portion 33 may be rotated in a left-right direction along with the front thigh portion 32 by the rotation of the front thigh portion 32.

In addition, the front calf portion 33 may be connected to the third front actuator 23 fastened to the front thigh portion 32. The third front actuator 23 may connect an upper end of the front calf portion 33 and a lower end of the front thigh portion 32.

The third front actuator 23 may rotate the front calf portion 33 about the rotation axis X3 (see FIG. 6) which is elongate in a left-right direction. Therefore, the front calf portion 33 may rotate in a front and rear direction with respect to the front thigh portion 32.

Meanwhile, the rear leg 40 may include a rear rotating body 51, a rear thigh portion 52, a rear calf portion 53, a first rear actuator 41 (see FIG. 10), a second rear actuator 42, and a third rear actuator 43. The rear leg 40 may further include a link assembly 60 for rotating the rear calf portion 53 while maintaining a certain angle with respect to the rear thigh portion 52.

The rear rotating body 51 may be provided at the rear portion of the body 10. The rear rotating body 51 may have a disc shape. The rear rotating body 51 may be connected to a first rear actuator 41 (see FIG. 10) embedded in the rear portion of the body 10.

The first rear actuator 41 may rotate the rear rotating body 51 about a rotation axis Y1 (see FIG. 10) which is elongated in a left-right direction.

The rear thigh portion 52 may be elongated in a vertical direction. The rear thigh portion 52, more specifically, the upper portion of the rear thigh portion 52 may be located outer than the rear rotating body 51. The upper portion of the rear thigh portion 52 may be connected to the rear rotating body 51, and the rear thigh portion 52 may be rotated in a front-rear direction by the rotation of the rear rotating body 51.

In addition, the rear thigh portion 52 may be connected to the second rear actuator 42 fastened to the rear rotating body 51. The second rear actuator 42 may connect an upper portion of the rear thigh portion 52 to the rear rotating body 51.

The second rear actuator 42 may rotate the rear thigh portion 52 about the rotation axis Y2 elongated in a front-rear direction. Accordingly, the rear thigh portion 52 may rotate left and right with respect to the rear rotating body 51.

The rear calf portion 53 may be elongated in a vertical direction. The rear calf portion 53 may be spaced downward from the rear thigh portion 52. The height of the rear calf portion 53 may be lower than the height of the front calf portion 53.

The upper end of the rear calf portion 53 may be connected to the lower end of the rear thigh portion 52 by the link assembly 60. The rear calf portion 53 may be rotated in a left-right direction along with the rear thigh portion 52 by the rotation of the rear thigh portion 52.

In addition, the rear calf portion 53 may be connected to the third rear actuator 43 fastened to the rear thigh portion 52. The third rear actuator 43 may connect the lower end of the rear thigh 52 and the link assembly 60.

In more detail, the link assembly 60 may include a first link 70 and a second link 80.

The first link 70 may connect the third rear actuator 43 and the rear calf portion 53. The first link 70 may be rotated by the third rear actuator 43 and may be rotatably connected to the rear calf portion 53.

The second link 80 may be located behind the first link 70 and may connect the rear thigh portion 52 and the rear calf portion 53. The second link 80 may be rotatably connected to the rear thigh portion 52 and the rear calf portion 53.

The third rear actuator 43 may rotate the first link 70 about the rotation axis Y3 (see FIG. 10) that is elongate in a left-right direction. As a result, the rear calf portion 53 may be rotated' in a front-rear direction while maintaining an angle with respect to the rear thigh portion 52.

Meanwhile, the robot according to the present embodiment may further include foot bodies 90 rotatably connected to the lower ends of the legs 20 and 40. The plurality of foot bodies 90 may include a front foot body 90A connected to the lower end of the front leg 20 and a rear foot body 90B connected to the lower end of the rear leg 40.

The foot body 90 may be rotatably connected to the lower ends of the calf portions 33 and 53. The foot body 90 may contact the floor F to support the robot.

However, referring to FIG. 2, the robot may sit in a state where at least one of the rear calf portion 53 or the second link 80 is in contact with the floor F instead of the rear foot body 90B. In this case, the rear portion of the body 10 may also be in contact with the floor (F), the robot may sit on the floor (F) stably.

On the other hand, the front to rear distance between the third front actuator 23 and the third rear actuator 43 may increase as it goes downward.

In more detail, the third front actuator 23 may be provided to be further inclined toward the front as it goes downward, and the third rear actuator 43 may be provided to be further inclined toward the rear as it goes downward.

As a result, the front to rear distances between the front foot body 90A and the rear foot body 90B may further increase while maintaining the front to rear distance between the front rotating body 31 and the rear rotating body 51. That is, the geometric stability of the robot supported by the plurality of foot bodies 90 with respect to the floor F may be improved.

Meanwhile, the rotating body 31 or 51 of the leg 20 or 40 may be referred to as a first movable part, the thigh portion 32 or 52 may be referred to as a second movable part, and the calf portion 33 or 53 may be referred to as a third movable part. That is, each leg 20 or 40 according to the present embodiment may include three actuators and three movable parts. However, it is also possible that the leg 20 or 40 may further include an additional movable part and actuator.

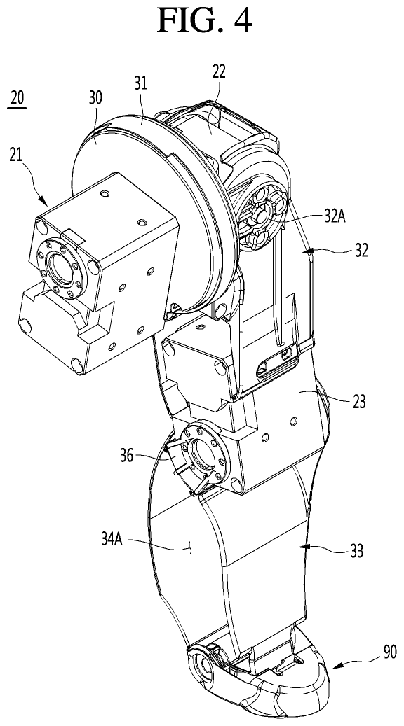

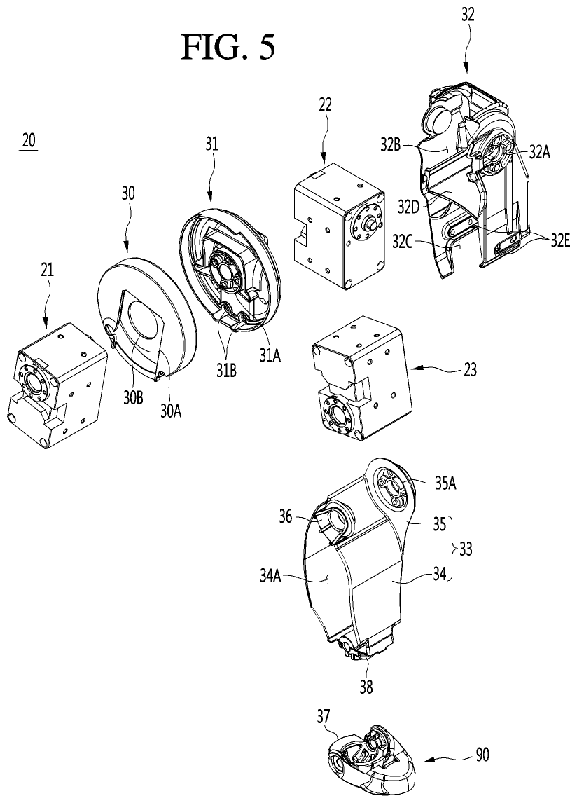

FIG. 4 is a perspective view of a front leg according to an embodiment of the present disclosure, FIG. 5 is an exploded perspective view of the front leg shown in FIG. 4, and FIG. 6 is a cross-sectional view of the front leg which is taken in a left-right direction according to an embodiment of the present disclosure.

Hereinafter, a configuration of the front leg 20 will be described in more detail.

Preferably, the first, second and third front actuators 21, 22 and 23 may be motors each including a housing and a rotor rotating outside the housing.

The first front actuator 21 may be embedded in the body 10. That is, a load of the first front actuator 21 may be supported by the body 10. Therefore, the load of the first front actuator 21 does not act as a driving load of the first front actuator 21 itself. As a result, the moving load of the first front actuator 21 is reduced as compared with the case where the first front actuator 21 is fasten to the front rotating body 31.

The first front actuator 21 may rotate the front rotating body 31. The rotor of the first front actuator 21 may face the opposite side of the body 10 with respect to the left-right direction. Therefore, the rotation axis X1 of the front rotating body 31 may be elongated in a left-right direction.

The front rotating body 31 may be provided on the side of the body 10. The front rotating body 31 may include a disc portion and a circumferential surface protruding toward the body 10 from the edge of the disc portion.

The front rotating body 31 may be provided with a rotor connection portion 31A connected to the rotor of the first front actuator 21. The rotor connection portion 31A may be positioned at the center of the first front rotating body 31.

The front leg 20 may further include a front guide body 30 for guiding the rotation of the front rotating body 31.

The front guide body 30 may have a disc shape and may be provided in the body 10. The front guide body 30 may be fixed to the body 10 and may not rotate.

The front guide body 30 may be disposed between the first front actuator 21 and the front rotating body 31. The outer circumference of the front guide body 30 may abut on the inner circumference of the front rotating body 31. This allows the front rotating body 31 to rotate reliably.

The front guide body 30 may be provided with a fitting groove 30A into which the housing of the first front actuator 21 is fitted, and a through hole 30B which is positioned in the fitting groove 30A and through which the rotor of the first front actuator 21 passes. The through hole 30B may be formed at a position corresponding to the rotor connection portion 31A of the front rotating body 31.

The second front actuator 22 may be fastened and fixed to the front rotating body 31. That is, the load of the second front actuator 22 may be supported by the front rotating body 31. Therefore, the load of the second front actuator 22 does not act as a driving load of the second front actuator 22 itself. As a result, the moving load of the second front actuator 22 is reduced as compared with the case where the second front actuator 22 is fastened to the front thigh portion 32.

More specifically, the front rotating body 31 may be provided with the fastening hole 31B that is fastened to the housing of the second front actuator 22. The fastening hole 31B may be positioned between the circumference of the front rotating body 31 and the rotor connection portion 31A. A fastening member such as a screw (not shown) may be fastened to the housing of the second front actuator 22 by passing through the fastening hole 31B.

The second front actuator 22 may rotate the front thigh portion 32. The rotor of the second front actuator 22 may face the front or rear side. Therefore, the rotation axis X2 (see FIG. 3) of the front thigh portion 32 may be elongated in a front to rear direction.

The front thigh portion 32 may be connected to the second front actuator 22 on the outside of the second front actuator 22.

The front thigh portion 32 may be provided with the rotor connection portion 32A to which the rotor of the second front actuator 22 is connected. The rotor connection portion 32A may face the inner side of the upper receiving portion 32B. The rotor connection portion 32A may be formed on any one of the front and rear surfaces of the upper receiving portion 32B.

The front thigh portion 32 may be provided with a housing connection portion to which the housing of the second front actuator 22 is rotatably connected. The housing connection portion may face the rotor connection portion 32A. That is, the housing connection portion may be formed on the other of the front and rear surfaces inside the upper receiving portion 32B. The rotor connection portion 32A and the housing connection portion may be positioned opposite to each other with respect to the second front actuator 22.

The front thigh portion 32 may receive an upper receiving portion 32B in which at least a part of the second front actuator 22 is received. The upper receiving portion 32B may be open toward the front rotating body 31. In addition, the upper receiving portion 32B may be open upward.

The front thigh portion 32 may be provided with a lower receiving portion 32C in which a part of the upper side of the third front actuator 23 is received. The lower receiving portion 32C may be positioned at the lower side of the upper receiving portion 32B. The lower receiving portion 32C may be open toward the body 10 or the lower side of the body 10. In addition, the lower receiving portion 32C may be open downward.

The front thigh portion 32 may be provided with a partition plate 32D for partition between the upper receiving portion 32B and the lower receiving portion 32C. The partition plate 32D may be located between the second front actuator 22 and the third front actuator 23.

The third front actuator 23 may be fastened and fixed to the front thigh portion 32. That is, the load of the third front actuator 23 may be supported by the front thigh portion 32. Therefore, the load of the third front actuator 23 does not act as a driving load of the third front actuator 23 itself. As a result, the moving load of the third front actuator 23 is reduced as compared with the case where the third front actuator 23 is fastened to the front calf portion 33.

In more detail, the front thigh portion 32 may be provided with the fastening hole 32E that is fastened to the housing of the third front actuator 23. The fastening hole 32E may be formed by passing through at least one of the front surface or the rear surface of the lower receiving portion 32C. A fastening member (not shown) such as a screw may be fastened to the housing of the third front actuator 23 by passing through the fastening hole 32E.

The third front actuator 23 may rotate the front calf portion 33. The rotor of the third front actuator 23 may face the left or right side. Therefore, the rotation axis X3 of the front calf portion 33 may be elongated in a left-right direction.

The front calf portion 33 may be positioned at the lower side of the front thigh portion 32. The front calf portion 33 may be connected to the third front actuator 23 at the lower side of the third front actuator 23.

The front calf portion 33 may include a body 34 and a connection portion 35 connected to the body 34 and connected to the third front actuator 23.

The body 34 may be formed be elongate in a vertical direction. The body 34 may have a shape that is substantially curved toward the rear. The front and rear surfaces of the body 34 may be curved.

The body 34 may be formed with an opening portion 34A open toward the lower side of the body 10 of the robot. Another part (not shown) such as a pressure sensor may be disposed in the opening portion 34A.

In addition, the foot body 90 described above may be rotatably connected to the lower end of the body 34.

The connection portion 35 may be provided at one side of the body 34. The connection portion 35 may protrude upward from the one side. The inner surface of the connection portion 35 may be connected to the front surface of the body 34. The connection portion 35 may be provided with the rotor connection portion 35A to which the rotor of the third front actuator 23 is connected.

The front calf portion 33 may further include a housing connection portion 36 to which the housing of the third front actuator 23 is rotatably connected. The housing connection portion 36 may face the connection portion 35, more particularly, the rotor connection portion 35A. That is, the housing connection part 36 may be provided on the other side of the body 34. The rotor connection part 35A and the housing connection part 36 may be located opposite to each other with respect to the third front actuator 23.

The front calf portion 33 may further include a heel 37. The heel 37 may be fastened to the lower end of the front calf portion 33. In more detail, the heel fastening portion 36 to which the heel is fastened may be formed at the lower end of the body 34.

On the other hand, the rotation axis X1 of the front rotating body 31 rotated by the first front actuator 21 may be perpendicular to the rotation axis X2 of the front thigh portion 32 which is rotated by the second front actuator 22 (see FIG. 3) and parallel to the rotation axis X3 of the front calf portion 33 which is rotated by the third front actuator 23.

In more detail, a rotation axis X1 of the front rotating body 31 and a rotation axis X3 of the front calf portion 33 may be elongated in a left-right direction, and the rotation axis X2 of the front thigh portion 32 may be elongated in a front-rear direction.

In addition, the rotation axis X1 of the front rotating body 31 may be positioned on the same horizontal plane P1 as the rotation axis X2 (see FIG. 3) of the front thigh portion 32. Thus, the front thigh portion 32 may operate as if it were connected to the body 10 by a spherical joint. That is, the front leg 20 may operate similar to the front leg of the actual pet.

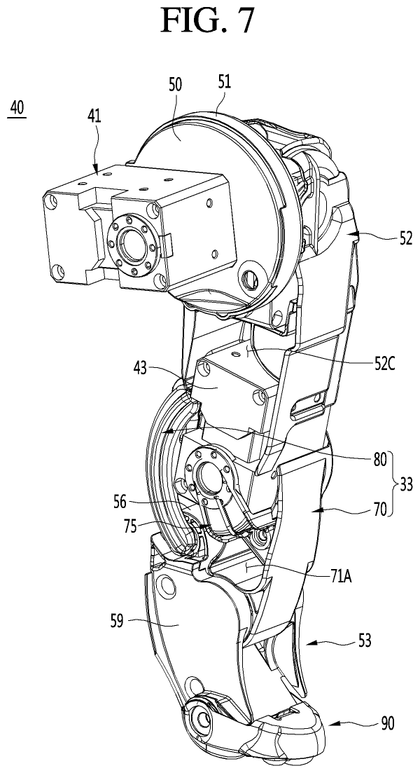

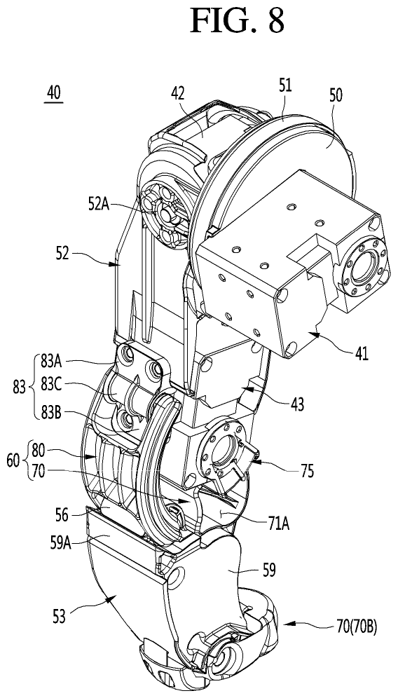

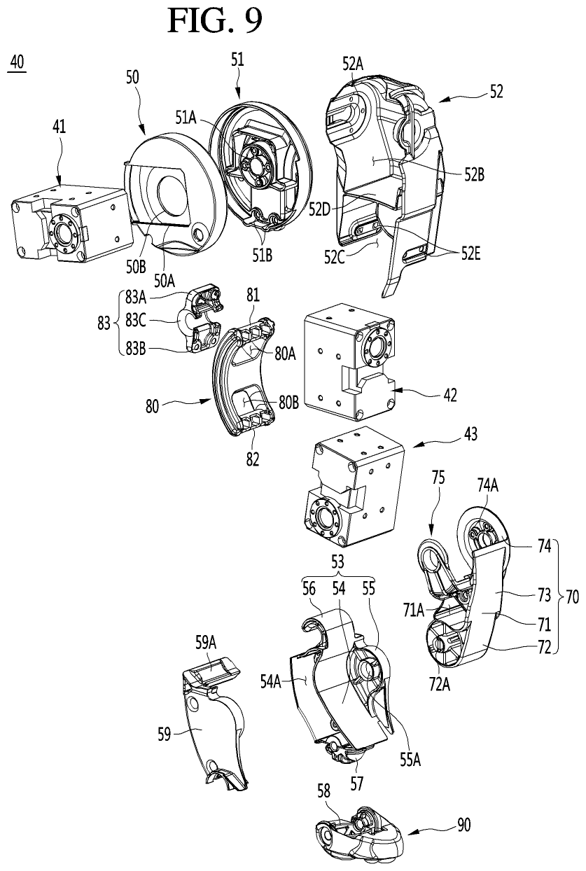

FIG. 7 is a perspective view of a rear leg according to an embodiment of the present disclosure, FIG. 8 is a perspective view of the rear leg shown in FIG. 7 viewed in another direction, FIG. 9 is an exploded perspective view of the rear leg shown in FIG. 7, and FIG. 10 is a cross-sectional view of the rear leg according to the embodiment of the present disclosure, which taken in the left-right direction.

Hereinafter, the configuration of the rear leg 20 will be described in more detail.

Preferably, first, second and third rear actuators 41, 42 and 43 are motors including a housing and a rotor rotating outside the housing.

The first rear actuator 41 may be embedded in the body 10. That is, the load of the first rear actuator 41 may be supported by the body 10. Therefore, the load of the first rear actuator 41 does not act as a driving load of the first rear actuator 41 itself. As a result, the moving load of the first rear actuator 41 is reduced as compared with the case where the first rear actuator 41 is fastened to the rear rotating body 51.

The first rear actuator 41 may rotate the rear rotating body 51. The rotor of the first rear actuator 41 may face the opposite side of the body 10 with respect to the left-right direction. Therefore, the rotation axis Y1 of the rear rotating body 51 may be elongated in a left-right direction.

The rear rotating body 51 may be provided at one side of the body 10. The rear rotating body 51 may include a disc portion and a circumferential surface protruding toward the body 10 from an edge of the disc portion.

The rear rotating body 51 may be formed with a rotor connection portion 51A connected to the rotor of the first rear actuator 41. The rotor connection portion 51A may be positioned at a center portion of the first rear rotating body 51.

The rear leg 40 may further include a rear guide body 50 for guiding the rotation of the rear rotating body 51.

The rear guide body 50 may have a disc shape and may be provided in the body 10. The rear guide body 50 may be fixed to the body 10 not to rotate.

The rear guide body 50 may be located between the first rear actuator 41 and the rear rotating body 51. The outer circumference of the rear guide body 50 may contact the inner circumference of the rear rotating body 51. Thereby, the rear rotating body 51 may rotate reliably.

The rear guide body 50 may have a fitting groove 50A into which the housing of the first rear actuator 41 is fitted, and a through hole which is positioned in the fitting groove 50A and through which the rotor of the first rear actuator 41 passes. The through hole 50B may be formed at a position corresponding to the rotor connection portion 51A of the rear rotating body 51.

The second rear actuator 42 may be fastened to and fixed to the rear rotating body 51. That is, the load of the second rear actuator 42 may be supported by the rear rotating body 51. Therefore, the load of the second rear actuator 42 does not act as a driving load of the second rear actuator 42 itself. As a result, the moving load of the second rear actuator 42 may be reduced as compared with a case where the second rear actuator 42 is fastened to the rear thigh portion 52.

More specifically, the rear rotating body 51 may be formed with a fastening hole 51B that is fastened to the housing of the second rear actuator 42. The fastening hole 51B may be positioned between the circumference of the rear rotating body 51 and the rotor connection portion 51A. A fastening member (not shown) such as a screw may be fastened to the housing of the second rear actuator 42 by passing through the fastening hole 51B.

The second rear actuator 42 may rotate the rear thigh portion 52. The rotor of the second rear actuator 42 may face the front or rear side. Therefore, the rotation axis Y2 (see FIG. 3) of the rear thigh portion 52 may elongated in a front-rear direction.

The rear thigh portion 52 may be connected to the second rear actuator 42 on the outside of the second rear actuator 42.

The rear thigh portion 52 may be provided with a rotor connection portion 52A to which the rotating body of the second rear actuator 42 is connected. The rotor connection portion 52A may face the inner side of the upper receiving portion 52B. The rotor connection portion 52A may be formed on any one of a front surface and a rear surface of the upper receiving portion 52B.

The rear thigh portion 52 may be provided with a housing connection portion to which the housing of the second rear actuator 42 is rotatably connected. The housing connection portion may face the rotor connection portion 52A. That is, the housing connection portion may be formed on the other one of the front and rear surfaces inside the upper receiving portion 52B. The rotor connection portion 52A and the housing connection portion may be positioned opposite to each other with respect to the second rear actuator 42.

The rear thigh portion 52 may receive an upper receiving portion 52B in which at least a part of the second rear actuator 42 is received. The upper receiving portion 52B may be open toward the rear rotating body 51. In addition, the upper receiving portion 52B may be open upward.

The lower thigh portion 52 may be provided with a lower receiving portion 52C in which a part of an upper portion of the third rear actuator 43 is received. The lower receiving portion 52C may be located under the upper receiving portion 52B. The lower receiving portion 52C may be open toward the body 10 or the lower side of the body 10. In addition, the lower receiving portion 52C may be open downward.

The rear thigh portion 52 may be formed with a partition plate 52D for partition between the upper housing portion 52B and the lower housing portion 52C. The partition plate 52D may be positioned between the second rear actuator 42 and the third rear actuator 43.

The third rear actuator 43 may be fastened and fixed to the rear thigh portion 52. That is, the load of the third rear actuator 43 may be supported by the rear thigh portion 52. Therefore, the load of the third rear actuator 43 does not act as a driving load of the third rear actuator 43 itself. As a result, the moving load of the third rear actuator 43 may be reduced as compared with a case in which the third rear actuator 43 is fastened to the rear calf portion 53 or the link assembly 60.

In more detail, the rear thigh portion 52 may be provided with a fastening hole 52E that is fastened to the housing of the third rear actuator 43. The fastening hole 52E may be formed to pass through at least one of the front surface or the rear surface of the lower receiving portion 52C. A fastening member (not shown) such as a screw may be fastened to the housing of the third rear actuator 43 by passing through the fastening hole 52E.

The third rear actuator 43 may rotate the link assembly 60, more specifically, a first link 70. The rotor of the third rear actuator 43 may face the left or right side. Therefore, the rotation axis Y3 of the first link 70 may be elongated in a left-right direction.

The rear calf portion 53 may be spaced apart from the lower side of the rear thigh portion 52. The rear calf 53 may be connected to the third rear actuator 43 and the rear thigh portion 52 by a link assembly 60. In more detail, the rear calf portion 53 may be connected to the third rear actuator 43 by the first link 70 and may be connected to the rear thigh portion 52 by the second link 80.

The rear calf portion 53 may include a body 54, a link connection portion 55 connected to the body 54 and rotatably connected to the first link 70, and a hook portion 56 formed at the upper end of the body 54 and rotatably connected to the second link 80.

The body 54 may be elongated in a vertical direction. The body 54 may have a shape that is substantially curved toward the rear. The front and rear surfaces of the body 54 may be curved.

The body 54 may be formed with an opening portion 54A open toward the lower side of the body 10 of the robot. Another part (not shown) such as a pressure sensor may be disposed in the opening portion 54A.

The foot body 90 described above may be rotatably connected to the lower end of the body 54.

The connection portion 55 may be provided at one side of the body 54. The connection portion 55 may protrude frontward from the one side. The inner surface of the connection portion 55 may be connected to the front surface of the body 54. A first connection groove 55A into which a connection shaft 72A of the first link 70 is inserted may be formed in the connection portion 55.

The hook portion 56 may protrude upward from the upper end of the front portion of the body 54 and be bent backward. The front surface of the hook portion 56 may be continuously connected to the front surface of the body 54.

The rear calf portion 53 may further include a cover 59 covering the opening 54A formed in the body 54 and rotatably connected to the first link 70.

The cover 59 may be provided on the other side of the body 54. A part of the cover 59 may cover the opening portion 54A formed in the body 54, and another part thereof may face the connection portion 55.

The cover 59 may be formed with a second connection groove into which the connection shaft 72A of the first link 70 is inserted. The second connection groove may be formed in a portion of the cover 59 facing the connection portion 55.

That is, one end of the connecting shaft 72A of the first link 70 may be inserted into the first connecting groove 55A formed in the connection portion 55, and the other end of the connection shaft 72A may be inserted into the second connecting groove formed in the cover 59. As a result, the rear calf portion 53 may be rotatably connected to the first link 70.

In addition, the cover 59 may be formed with a dislodgement preventing portion 59A to prevent the second link 80 from being dislodged from the hook portion 56.

The dislodgement preventing portion 59A may protrude outward from the cover 59. The dislodgement preventing portion 59A may close a gap between the end of the hook portion 56 and the upper surface of the body 54. Therefore, the dislodgement preventing portion 59A may prevent the lower connection portion 82 of the second link 80 from being dislodged from the hook portion 56.

The rear calf portion 53 may further include a heel 58. The heel 58 may be fastened to the lower end of the rear calf portion 53. In more detail, the heel fastening portion 57 to which the heel 58 is fastened may be formed at the lower end of the body 54.

On the other hand, the first link 70 may connect the third rear actuator 43 and the rear calf portion 53.

The first link 70 may include a body 71, a lower connection portion 72 positioned at a lower side of the body 71 and rotatably connected to the rear calf portion 53, an extension portion 73 extending upward from the front surface of the body 71, and an upper connection portion 74 provided at one side of the extension portion 73 and connected to the third rear actuator 43.

The body 71 may have a shape that is substantially curved toward the front. The front and rear surfaces of the body 71 may have a curved shape. The body 71 may be formed with an opening portion 71A which is open toward the lower side of the body 10 of the robot.

The lower connection portion 72 may be positioned at the lower side of the main body 71. The front surface of the lower connection portion 72 may be continuously connected to the front surface of the body 71. The lower connection portion 72 may be positioned between the connection portion 55 of the thigh portion 53 and the cover 59 with respect to the left-right direction.

The lower connection portion 72 may include a connection shaft 72A rotatably connected to the rear calf portion 53. The connection shaft 72A may protrude left and right from the lower connection portion 72.

As described above, one end of the connection shaft 72A may be inserted into the first connection groove 55A formed in the connection portion 55 of the rear calf portion 53. The other end of the connection shaft 72A may be inserted into a second connecting groove formed in the cover 59 of the rear calf portion 53.

An extension portion 73 may be formed to extend upward from the upper end of the front portion of the body 71. The front surface of the extension portion 73 may be continuously connected to the front surface of the body 71.

The upper connection portion 74 may be provided on one side of both left and right sides of the extension portion 73. The upper connection portion 74 may face the upper side of the body. The inner surface of the upper connection portion 74 may be connected to the rear surface of the extension portion 73. The upper connection portion 74 may be formed with a rotor connection portion 74A to which the rotor of the third rear actuator 43 is connected.

The first link 70 may further include a housing connection portion 75 to which the housing of the third rear actuator 43 is rotatably connected. The housing connection portion 75 may face the upper connection portion 74, more particularly the rotor connection portion 74A. That is, the housing connection portion 75 may be provided on the other side of the extension 73. The rotor connection portion 74A and the housing connection portion 75 may be positioned opposite to each other with respect to the third rear actuator 43.

The second link 80 may connect the rear thigh portion 52 and the rear calf portion 53. The second link 80 may be located behind the first link 70 and the third rear actuator 43. The second link 80 may have an arch shape which is bent backward.

The second link 80 may include an upper connection portion 81 rotatably connected to the rear thigh portion 52, and a lower connection portion 82 rotatably connected to the rear calf portion 53.

The upper connection portion 81 and the lower connection portion 82 may have a bar shape that is elongated in the left-right direction. The upper connection portion 81 may be provided at the upper end of the second link 80, and the lower connection portion 82 may be provided at the lower end of the second link 80.

In addition, an upper through hole 80A through which the connecting body 83 passes and a lower through hole 80B through which the hook portion 56 passes may be formed in the second link 80.

The upper connection portion 81 may define an upper inner circumference of the upper through hole 80A. The lower connection portion 82 may define a lower inner circumference of the lower through hole 80B.

The hook portion 56 of the rear calf portion 53 described above may pass through the lower through hole 80B, and may surround the lower connection portion 82 at the front side thereof. In addition, the dislodgement preventing portion 59A of the cover 59 may cover the lower connection portion 82 at the rear thereof. As a result, the hook portion 56 and the dislodgement preventing portion 59A may rotatably restrain the lower connection portion 82 of the second link 80.

The rear leg 40 may further include a connecting body 83 for rotatably connecting the second link 80 to the rear thigh portion 52. In more detail, the connecting body 83 may rotatably connect the upper connection portion 81 of the second link 80 to the rear thigh portion 52.

The connecting body 83 may include a first fastening portion 83A fastened to the rear thigh part 52, a second fastening portion 83B fastened to the second rear actuator 42, and a connecting portion 83C which is configured to connect the first fastening portion 83A and the second fastening portion 83B, and to which the second link 80 is connected.

The first fastening portion 83A may be fastened to the rear surface of the rear thigh portion 52. The second fastening portion 83B may be fastened to the housing of the third rear actuator 43. However, the first fastening portion 83A and the second fastening portion 83B may be both fastened to the rear surface of the rear thigh portion 52.

The connecting portion 83C may connect the first fastening portion 83A and the second fastening portion 83B. The connecting portion 83C may have an arch shape that is bent backward.

The connecting portion 83C may pass through the upper through hole 80A of the second link 80, and may surround the upper connection portion 81 of the second link 80 at the rear side thereof. Thereby, the connecting portion 83C may rotatably restrain the upper connection portion 81.

Meanwhile, the upper connection portion 74 and the lower connection portion 72 of the first link 70 may be referred to as the first upper connection portion 74 and the first lower connection portion 72 and the upper of the second link 80. The upper connection portion 81 and the lower connection portion 82 may be referred to as a second upper connection portion 81 and a second lower connection portion 82.

The second upper connection portion 81, the first upper connection portion 74, the second lower connection portion 82, and the first lower connection portion 72 may be positioned to be sequentially lower with respect to the floor F. That is, the second upper connection portion 81 may be located at a higher point than the first upper connection portion 74. In addition, the second lower connection portion 82 may be located at a higher point than the first lower connection portion 72 and at a lower point than the first upper connection portion 74.

As a result, the link assembly 60 may smoothly move the rear calf portion 53 while maintaining an angle of the rear calf portion 53 with respect to the rear thigh portion 52.

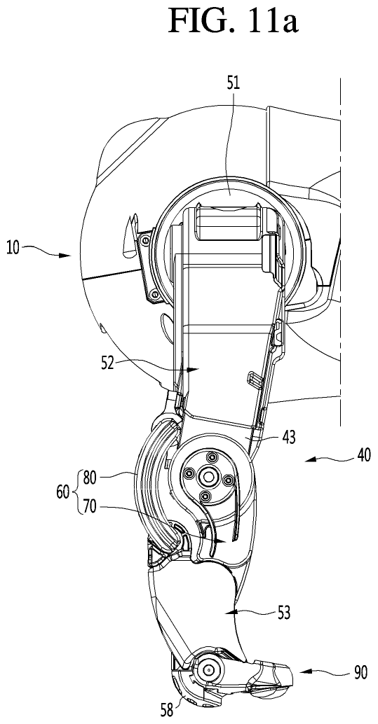

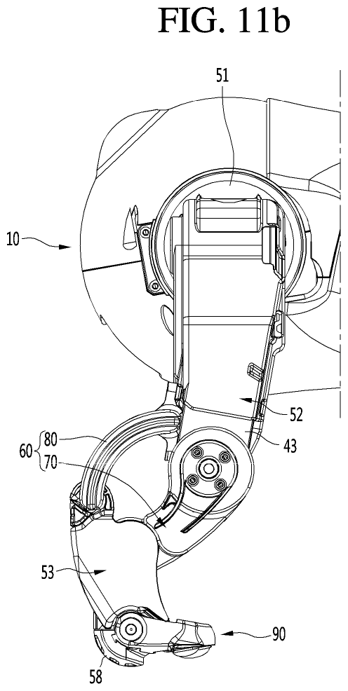

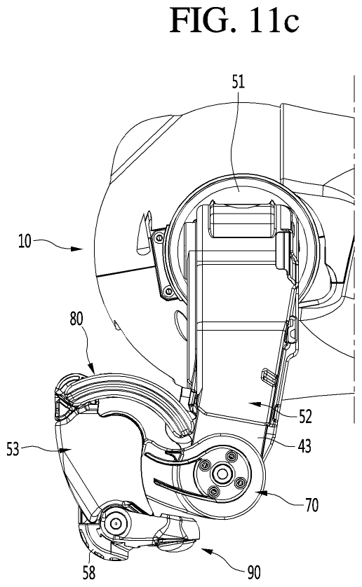

FIGS. 11A, 11B and 11C are views for describing operation of a link assembly of the present disclosure.

As shown in FIG. 11A, the rear thigh portion 52 and the rear calf portion 53 may be positioned on one vertical line. In this state, when the third rear actuator 43 rotates the first link 70 backward, the rear calf portion 53 rotatably connected to the first link 70 may be moved backward. In this case, since the second link 80 is rotatably connected to the rear thigh portion 52 and the rear calf portion 53, the posture of the rear calf portion 52 may be kept constant.

Accordingly, as shown in FIG. 11B, the rear thigh portion 52 and the rear calf portion 53 may be approximately parallel to each other. In addition, the central portions of the first link 70 and the second link 80 may be far from each other.

In this state, when the third rear actuator 43 rotates the first link 70 backward, as shown in FIG. 11C, the first link 70 may be in contact with or be adjacent to the foot body 90. In addition, the second link 80 may be in contact with or be adjacent to the body 10.

In addition, since the first link 70 and the second link 80 are convexly curved in opposite directions, interference between the first link 70 and the second link 80 does not occur and thus, further increasing a movable range.

According to the preferred embodiments, the own weight of one actuator included in the leg may not act as a moving load of the one actuator itself. Therefore, the moving load of each actuator may be reduced.

In addition, the thigh portion may be formed with an upper receiving portion in which at least a part of the second actuator is received. As a result, the leg may be compact in the left-right direction, and the load on the thigh portion may be reduced, thereby reducing the moving load of the second actuator.

In addition, the thigh portion may be formed with a lower receiving portion in which a part of the upper portion of the third actuator is received. As a result, the leg may be compact in the vertical direction, and the load on the thigh portion may be reduced, thereby further reducing the moving load of the second actuator.

In addition, the rotation axis of the rotating body may be positioned on the same horizontal plane as the rotation axis of the thigh portion. Accordingly, the thigh portion may be operated as if it were connected to the body by a spherical joint. That is, the leg may operate similar to the front leg of the actual pet.

In addition, an opening portion may be formed in the body of the calf portion. As a result, a component such as a sensor may be arranged, and the load on the calf portion may be reduced, thereby leading to a decrease in the moving load of the third actuator.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments.

The scope of the present disclosure should be construed on the basis of the accompanying claims, and all the technical ideas within the scope equivalent to the claims should be included in the scope of the present disclosure.

What is claimed is:

1. A pet robot in a shape of an animal, the pet robot comprising:
a torso member;
a first actuator located in the torso member;
a rotating body located in the torso member and connected to the first actuator to rotate about a first axis;
a second actuator connected to the rotating body;
a thigh member having an upper portion and a lower portion, the upper portion of the thigh member being connected to the second actuator to rotate about a second axis different from the first axis;
a third actuator connected to the lower portion of the thigh member; and
a calf member having an upper portion and a lower portion, the calf member being located at the lower portion of the thigh member, the upper portion of the calf member being connected to the third actuator to rotate about a third axis different from the second axis.

2. The pet robot of claim 1, wherein the thigh member includes an upper receiving portion open toward the rotating body to receive at least a part of the second actuator.

3. The pet robot of claim 2, wherein the thigh member includes a lower receiving portion located at a lower side of the upper receiving portion and open toward the torso member or a lower side of the torso member to receive a part of an upper portion of the third actuator.

4. The pet robot of claim 1, wherein the first axis is perpendicular to the second axis and parallel to the third axis.

5. The pet robot of claim 1, wherein the first axis is located on a same plane as the second axis.

6. The pet robot of claim 1, wherein the calf member includes:
a calf body; and
a connection portion formed at one side of the calf body, the connection portion being connected to the third actuator.

7. The pet robot of claim 6, wherein the calf body is provided with an opening portion open toward a lower side of the torso member.

8. The pet robot of claim 1, further comprising a guide body fixed to the torso member, the guide body being located between the first actuator and the rotating body to guide rotation of the rotating body.

9. The pet robot of claim 8, wherein the guide body includes a through hole, and
wherein the first actuator is connected to the rotating body via the through hole.

10. A pet robot in a shape of an animal, the pet robot comprising:
a torso member;
a first actuator located in the torso member;
a rotating body located in the torso member and connected to the first actuator to rotate about a first axis;
a second actuator connected to the rotating body;
a thigh member having an upper portion and a lower portion, the upper portion being connected to the second actuator to rotate about a second axis different from the first axis;
a third actuator connected to the lower portion of the thigh member;
a calf member spaced apart from a lower side of the third actuator; and
a link assembly connecting the thigh member to the calf member, the link assembly being configured to rotate the calf member while maintaining the calf member at a predetermined angle with respect to the thigh member as the calf member rotates.

11. The pet robot of claim 10, wherein the link assembly includes:
a first link interconnecting the third actuator and the calf member; and
a second link interconnecting the thigh member and the calf member, the second link being located behind the first link.

12. The pet robot of claim 11, wherein the calf member includes:
a calf body;
a link connection located at one side of the calf body and connected to the first link; and
a hook portion located at an upper end of the calf body and connected to the second link.

13. The pet robot of claim 12, wherein the calf body includes an opening portion configured to be open to a lower end of the torso member.

14. The pet robot of claim 13, wherein the calf member further includes a cover configured to cover the opening portion and rotatably connected to the first link.

15. The pet robot of claim 14, wherein the cover includes a stopper configured to prevent the second link from being disconnected from the hook portion.

16. The pet robot of claim 10, further comprising a foot member rotatably connected to a lower end of the calf member.

17. The pet robot of claim 11, wherein the first link includes:
a first link body;
a lower connection portion located at a lower side of the first link body and rotatably connected to the calf member;
an extension portion extending upward from a front surface of the first link body; and
an upper connection portion located at one side of the extension portion and connected to the third actuator.

18. The pet robot of claim 17, wherein the first link body includes an opening portion configured to be open to a lower side of the torso member.

19. A pet robot in a shape of an animal, the pet robot comprising:
a torso member;
a first front actuator located in a front portion of the torso member;
a front rotating body located in the front portion of the torso member and connected to the first front actuator to rotate about a first front axis;
a second front actuator connected to the front rotating body;
a front thigh member having an upper portion and a lower portion, the upper portion of the front thigh member being connected to the second front actuator to rotate about a second front axis different from the first front axis;
a third front actuator connected to the lower portion of the front thigh member;
a front calf member having an upper portion and a lower portion, the front calf member being located at the lower portion of the front thigh member, the upper portion of the front calf member being connected to the third front actuator to rotate about a third front axis different from the second front axis;
a first rear actuator located in a rear portion of the torso member;
a rear rotating body located in the rear portion of the body and connected to the first rear actuator to rotate about a first rear axis;
a second rear actuator connected to the rear rotating body;
a rear thigh member having an upper portion and a lower portion, the upper portion connected to the second rear actuator to rotate about a second rear axis different from the first rear axis;
a third rear actuator connected to the lower portion of the rear thigh member;
a rear calf member spaced apart from a lower side of the third rear actuator; and
a link assembly connecting the rear thigh member to the rear calf member, the link assembly being configured to rotate the rear calf member while maintaining the rear calf member at a predetermined angle with respect to the rear thigh member as the rear calf member rotates.

20. The pet robot of claim 19, wherein a front to rear distance between the third front actuator and the third rear actuator increases as the torso member is lowered toward a ground.
